(19) United States
(12) Patent Application Publication
(10) Pub. No.: US 2010/0135562 A1
(43) Pub. Date: Jun. 3, 2010

(54) COMPUTER-AIDED DETECTION WITH ENHANCED WORKFLOW

(75) Inventors: Michael Greenberg, Jerusalem (IL); Isaao Leichter, Jerusalem (IL); Jonathan STOECKEL, RB Hierden (NL)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Computer Aided Diagnosis Ltd., Jerusalem, IL (US)

(21) Appl. No.: 12/625,499

(22) Filed: Nov. 24, 2009

Related U.S. Application Data
(60) Provisional application No. 61/118,585, filed on Nov. 28, 2008.

(51) Int. Cl. G06K 9/00; G06K 9/46

(52) U.S. Cl. 382/131; 382/195; 382/170; 382/254

(57) ABSTRACT

Described herein is a technology for supporting an efficient workflow. In one implementation, a computer system receives at least one image of a subject and at least one corresponding image finding (302). The image finding identifies one or more regions-of-interest in a subject area of the image. The computer system generates enhanced annotations based on the image finding (306), overlays the enhanced annotations on the image (310) and displays (312) the resulting image to facilitate image assessment by a skilled user.

### CROSS-REFERENCE TO RELATED APPLICATION

The present application claims the benefit of U.S. provisional application No. 61/118,585 filed Nov. 28, 2008, the entire contents of which are herein incorporated by reference.

### TECHNICAL FIELD

The present disclosure relates generally to processing of images, and more particularly to presenting image-based information to facilitate an enhanced workflow.

### BACKGROUND

Computer-aided detection (CAD) tools have been developed for various clinical applications to provide for automated detection and diagnosis of medical conditions. CAD systems generally employ digital signal processing of image data to assist physicians, radiologists, clinicians etc. in evaluating medical images to diagnose medical conditions. For example, CAD systems may be employed to automatically detect and diagnose possible abnormal conditions such as colonic polyps, lung nodules, lesions, aneurysms, calcification on heart or artery tissue, micro-calcifications or masses in breast tissue, and various other lesions or abnormalities.

CAD technology typically works like a second pair of eyes to assist the radiologist in evaluating medical images. For example, the radiologist may first make initial impressions by manually reviewing medical images to discern characteristic regions of interest. Subsequently, the CAD software may be used to automatically detect and mark the regions of interest. The radiologist may then return to inspect the marked regions of interest to determine whether the marked regions are indeed suspicious and require further examination. During this inspection process, the radiologist typically has to manually adjust the images to obtain a better view. For example, the radiologist may have to manually enable or disable the display of CAD marks when they obstruct parts of the medical image, or adjust the windowing levels of the image to better view the CAD marks. The radiologist then makes final impressions based on this inspection.

Alternatively, CAD technology can serve as a concurrent pair of eyes to facilitate the radiologist in reviewing the medical image. A radiologist selects a case to review and the viewing station presents the CAD marks on the medical images and other patient information to the radiologist for evaluation. To better read the case, the radiologist may have to manually manipulate the image and the CAD marks, as previously described. The radiologist then makes final impressions based on this inspection.

Such manual inspection, however, is often tedious and error-prone. The radiologist is often distracted from the task of evaluating the CAD marks by having to manually manipulate the images and perform non-CAD steps in order to better inspect the images. Thus, there is a need for a workflow that is not interrupted by such manual adjustment, and thereby provides for increased efficiency and accuracy in diagnosis.

### SUMMARY

A technology for supporting an enhanced workflow is described herein. In one implementation, a computer system receives at least one image of a subject and at least one corresponding image finding. The image finding identifies one or more regions-of-interest in a subject area of the image. The computer system generates enhanced annotations based on the image finding. The enhanced annotations include, for example, a magnified sub-image of the region-of-interest. The enhanced annotations are then overlaid on the image and displayed to facilitate image assessment by a skilled user.

### BRIEF DESCRIPTION OF THE DRAWINGS

The same numbers are used throughout the drawings to reference like elements and features.

FIG. 1 is a block diagram illustrating an exemplary image processing system.

FIG. 2 shows an exemplary method which may be implemented by the image processing unit.

FIGS. 3a-b show an exemplary method which may be implemented by the viewing station.

FIGS. 4-5 show exemplary workflows supported by the image processing system.

FIG. 6 shows an exemplary mammogram with enhanced annotations.

### DETAILED DESCRIPTION

In the following description, for purposes of explanation, specific numbers, materials and configurations are set forth in order to provide a thorough understanding of the present systems and methods and in order to meet statutory written description, enablement, and best-mode requirements. However, it will be apparent to one skilled in the art that the present systems and methods may be practiced without the specific exemplary details. In other instances, well-known features are omitted or simplified to clarify the description of the exemplary implementations of present systems and methods, and to thereby better explain the present systems and methods. Furthermore, for ease of understanding, certain method steps are delineated as separate steps; however, these separately delineated steps should not be construed as necessarily order dependent in their performance.

The following description sets forth one or more implementations of systems and methods that facilitate an enhanced workflow. One aspect of the present technology automatically generates enhanced annotations which present pertinent diagnostic information in a user-friendly and intuitive format. The enhanced annotation may include a magnified sub-image of a region-of-interest, an overlaid CAD mark and/or textual information derived from image findings. The magnified sub-image may be locally enhanced to improve its visual quality or resolution. In addition, the sub-image may be processed to improve the visibility of relevant information. This can be done by, for example, automatically suppressing non-relevant information or by enhancing relevant information. By improving the visibility and layout of such imaged-based information without much user intervention, such enhanced annotations greatly improve the efficiency of the diagnostic or inspection process.

Another aspect of the present technology automatically arranges the enhanced annotations in a layout that satisfies one or more pre-defined spatial constraints. One exemplary spatial constraint avoids overlap between enhanced annotations. Another exemplary spatial constraint avoids any overlap between the enhanced annotations and the subject area of the image. By presenting enhanced annotations in such a way that does not obscure areas of diagnostic interest, the user is able to inspect and analyze the image more effectively and efficiently, without being distracted by having to manually manipulate the image in order to obtain a better view.

It is noted that while a particular application directed to mammography reading is shown, the invention is not limited to the specific embodiment illustrated. The present technology has application to the display of CAD marks (or annotations) for any two-dimensional imaging modalities, including X-ray based CAD systems (e.g., chest X-ray), computed tomographic (CT) systems (e.g., LungCAD, ColonCAD), ultrasound systems, nuclear medicine and imaging catheters. Other types of imaging modalities, such as helical CT, X-ray, positron emission tomographic, fluoroscopic, and single photon emission computed tomographic (SPECT) systems, may also be used. In addition, with some modifications as to how the enhanced annotations are positioned (and rendered), the present technology also has application to three-, four- or any other multi-dimensional imaging modalities (e.g, tomography, CT).

Even further, the invention is not limited to medical diagnostic applications. The present technology may be used in any application where computer software provides annotations in the presentation of image-based information. Such applications include, for example, navigation systems and diagnostic systems that detect problems in mechanical systems. Other types of annotation-based applications are also useful.

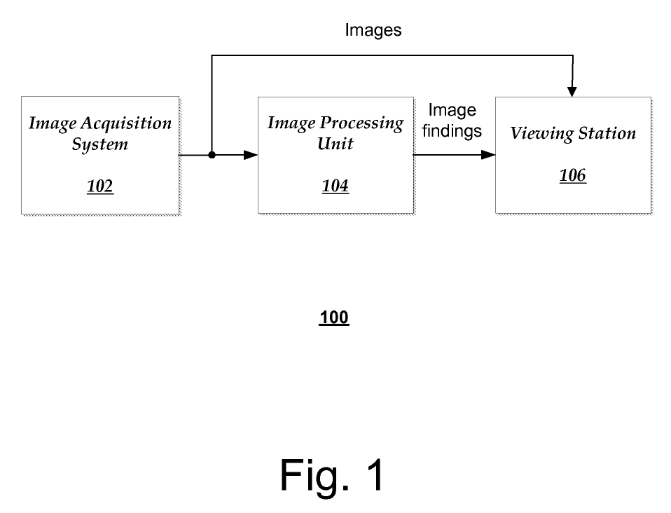

FIG. 1 is a block diagram illustrating an exemplary image processing computer system 100 that may be used to implement the exemplary techniques described herein for supporting an enhanced workflow. The workflow may be, for example, a CAD workflow for detecting or diagnosing potential abnormal anatomical structures in the subject image dataset. In general, the exemplary computer system 100 includes an image acquisition system 102, an image processing unit 104 and a viewing station 106. Other components (not shown), such as a repository or database of patient records or files, may also be provided.

Image acquisition system 102 acquires digital image data of a subject, and provides the image data to the image processing unit 104 for analysis and the viewing station 106 for presentation to the user. The image data may be in the form of raw image data (e.g., MRI or CT data) acquired during a scan. In one implementation, the image acquisition system is a radiology imaging system such as a MR scanner or a CT scanner. Other types of modalities may also be used. For example, the image data may be acquired by an imaging device using a magnetic resonance (MR) imaging, computed tomographic (CT), helical CT, X-ray, positron emission tomographic, fluoroscopic, ultrasound, single photon emission computed tomographic (SPECT), or mammography technique. In addition, the image data may include two-dimensional (2D) slices (e.g., mammography image), three-dimensional (3D) volumetric images, or four-dimensional (4D) images. The subject in the image data may be a human organ or anatomical part (e.g., lung, breast) or any other human or non-human feature of interest.

The image processing unit 104 analyzes the images and provides image findings to the viewing station 106 for display with the images. In one implementation, the image processing unit 104 comprises methods or modules for processing digital image data. Non-image data, such as textual subject data (e.g., patient data or case information), may also be processed.

In one implementation, the image processing unit 104 implements methods for generating CAD image findings. The CAD image findings identify, or at least localize, certain regions-of-interest (ROIs) corresponding to suspicious abnormalities in the input image dataset. An ROI refers to an area or volume identified for further study and processing. In particular, an ROI may be associated with an abnormal condition. For example, the ROI may represent a potentially malignant lesion, tumor or mass in the patient's body. The locations or shapes of these ROIs are indicated by CAD marks rendered as overlays on the images. The CAD marks may be rendered as pointers (e.g., cross-hairs or arrows) that point to the ROIs. For example, a CAD mark may be placed at the centre location of each ROI. Alternatively, the CAD marks may be simple shapes (e.g., circle, square, rectangle) delineating the ROIs. Irregular shapes forming the perimeter or boundary of the ROI may also be generated. The shape may be represented by solid or broken lines formed around the perimeter or the edge of the ROI, or a solid area formed within the ROI.

The image processing unit 104 may further generate enhanced annotations. Alternatively, enhanced annotations may be generated by the viewing station 106. The enhanced annotations provide pertinent information in a user-friendly and intuitive format that facilitates inspection of the image data by the user. The user may be, for example, a radiologist, physician, technician, operator or any other person. In one implementation, the enhanced annotations include a magnified sub-region of the image corresponding to the CAD mark. Local image enhancements may be automatically applied to the sub-image. In addition, the enhanced annotations may include textual CAD information and other useful information that may be used for diagnosis. The enhanced annotations may be automatically arranged in an optimized layout. For example, each enhanced annotations may be placed as close to the corresponding CAD mark as possible. In addition, the layout may be determined such that the enhanced annotations do not obstruct the subject area in the image. More details of such enhanced annotations will be provided below.

The viewing station 106 communicates with the image acquisition unit 102 and the image processing unit 104 so that the acquired and/or processed image data may be presented at the viewing station 106. The viewing station 106 may include any system or method that is suitable for generating renderings of the image data in accordance with the image findings. For example, the viewing station 106 may overlay the enhanced annotations and CAD marks on rendered image data for display. In addition, the viewing station 106 may further include a user interface (e.g., graphical user interface) that enables the user to select the case for review and to navigate through or manipulate the image data.

The image processing unit 104 and the viewing station 106 may be embodied in separate computer systems. Alternatively, the image processing unit 104 and the viewing station 106 may be embodied in the same computer system. A computer system can be a desktop personal computer, portable laptop computer, another portable device, a mini-computer, a mainframe computer, a server, a storage system, a dedicated digital appliance, or another device having a storage sub-system configured to store a collection of digital data items. In one implementation, the computer system comprises a processor or central processing unit (CPU) coupled to one or more computer-usable media (e.g., computer storage or memory), display device (e.g., monitor) and various input devices (e.g., mouse or keyboard) via an input-output interface. The computer system may further include support circuits such as a cache, power supply, clock circuits and a communications bus.

It is to be understood that the present technology may be implemented in various forms of hardware, software, firmware, special purpose processors, or a combination thereof. Computer-usable media in the image processing unit 104 and/or the viewing station 106 may include random access memory (RAM), read only memory (ROM), magnetic floppy disk, flash memory, and other types of memories, or a combination thereof.

In one implementation, the techniques described herein may be implemented as computer-readable program code tangibly embodied in the computer-usable media. The computer-readable program code may be executed by processor in the image processing unit 104 and/or the viewing station 106, so as to process images from the image acquisition system 102. As such, the computer system is a general-purpose computer system that becomes a specific purpose computer system when executing the computer-readable program code. The computer-readable program code is not intended to be limited to any particular programming language and implementation thereof. It will be appreciated that a variety of programming languages and coding thereof may be used to implement the teachings of the disclosure contained herein.

The computer system may also include an operating system and microinstruction code. The various techniques described herein may be implemented either as part of the microinstruction code or as part of an application program or software product, or a combination thereof, which is executed via the operating system. Various other peripheral devices, such as additional data storage devices, printing or output devices, may also be connected to the computer system.

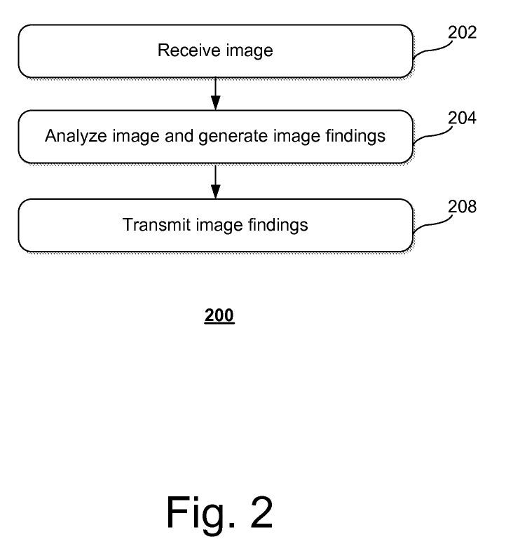

FIG. 2 shows an exemplary method 200 which may be implemented by the image processing unit 104. In the discussion of FIG. 2 and subsequent figures, continuing reference will be made to elements and reference numerals shown in FIG. 1.

At 202, the image processing unit 104 receives at least one image from, for example, the image acquisition system 102. The image can be one that is reconstructed from an acquired image dataset. As discussed previously, the image may be a multi-dimensional image, such as a 2D or 3D image, of a subject under consideration. The imaged subject can be an anatomical part (e.g., breast, lung) or any other human or non-human structure. In one implementation, the image comprises a medical diagnostic image such as an X-ray mammography image. Alternatively, in non-medical applications, the image comprises a navigation map or any other type of image that provides image-based information.

At 204, the images are analyzed to generate one or more image findings, which provide information about the subject of the image. The image analysis may be performed automatically by the image processing unit 104. Alternatively, some or all of the image analysis may be performed manually by a skilled user, such as a radiologist or a physician.

In one implementation, the image findings include medical diagnostic findings such as CAD findings, which assist physicians in the interpretation of medical images to identify the medical condition of the patient. Other types of image findings, such as non-medical or non-diagnostic findings, may also be generated. The image findings may include, for example, the location and/or shape (e.g. CAD mark) that indicating (or delineating) a region-of-interest (ROI). The image processing unit 104 may automatically process the image using a CAD process to detect the ROI. For example, a segmentation technique that detects points where the increase in voxel intensity is above a certain threshold may be employed. Alternatively, the ROI may be delineated manually by, for example, a skilled user via a user-interface at the viewing station 106.

In addition, the image findings may further include additional CAD details or attributes, such as the type of lesion, certainty of finding, number of microcalcifications, lesion size or density, or a combination thereof. Other information, such as the identification and location of the anatomical part where the ROI is located (e.g., position of the nipple, boundary of the breast), may also be included in the image findings.

At 208, such image findings are transmitted to the viewing station 106 for display. The image findings may be transmitted via a radio wave or over a wire connected between the image processing unit 104 and the viewing station 106. Alternatively, the image findings may be tangibly embodied or stored in a computer-usable media, such as a random access memory (RAM), read only memory (ROM), magnetic floppy disk, flash memory, and other types of memories, or a combination thereof. The viewing station 106 may retrieve the image findings from the computer-usable media for rendering and display.

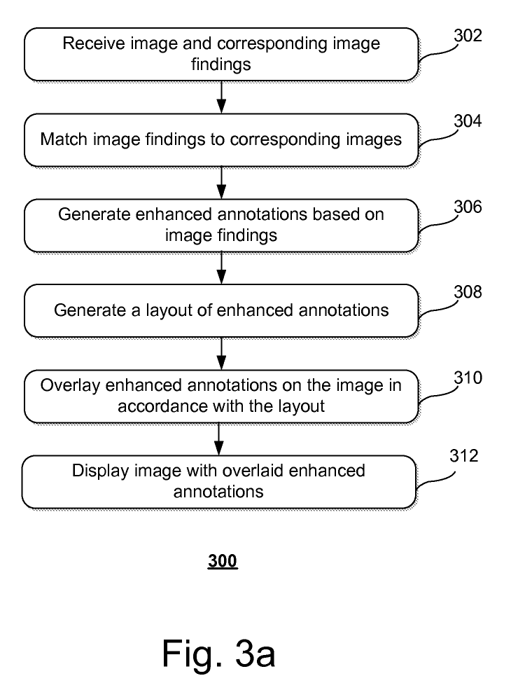

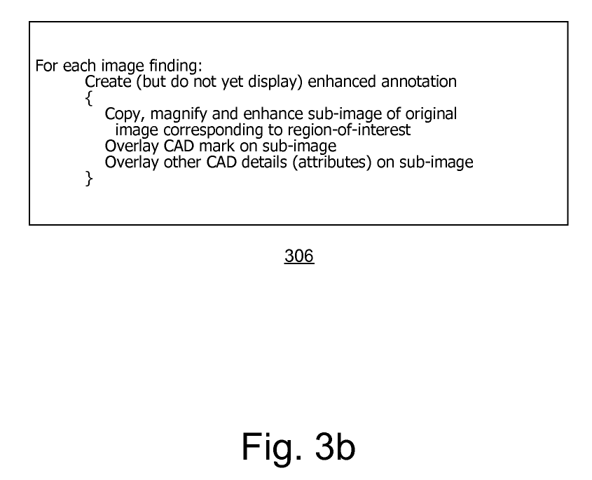

FIGS. 3a-b show an exemplary method 300 which may be implemented by the viewing station 106. It is to be understood that one or more of the steps in exemplary method 300 may also be implemented by the image processing unit 104.

Referring to FIG. 3a, at 302, the viewing station 106 receives one or more images of a subject and corresponding image findings. As discussed previously, the images may be provided by, for example, image acquisition system 102. The image findings identify or provide information about one or more regions-of-interest (ROIs) in a subject area of the corresponding image. The subject area is the portion of the image corresponding to the imaged subject (e.g., breast or lung).

At 304, the viewing station 106 matches image findings to the corresponding images. This may be done by, for example, looking up a data structure (e.g., table or database) that enables cross-referencing of a particular image finding with the corresponding image. Each image may be assigned with, for example, a unique identifier that can be used for cross-referencing.

At 306, enhanced annotations are generated based on the image findings. The enhanced annotations may be generated by either the viewing station 106 or the image processing unit 104.

FIG. 3b illustrates an exemplary sub-routine 306 for generating the enhanced annotations. The enhanced annotation is generated by first generating a sub-image of the ROI for each image finding. The sub-image advantageously enhances the visibility of the ROI for ease of inspection. The sub-image may be generated by copying and magnifying a portion of the image corresponding to the ROI. Alternatively, in the case where the image processing unit 104 is used to generate the enhanced annotations, the sub-image may be copied from the generated image findings. The magnification factor may be in the range of approximately 0.5 times to 2.0 times. Other suitable ranges may also be used. The magnification factor, along with other enhancement parameters, may be stored in memory and automatically retrieved and applied to the sub-image. Alternatively, the user may provide the magnification factor and/or other parameters at the viewing station 106 via an input device (e.g., mouse, keyboard).

In addition, localized enhancement (or optimization) may be automatically performed to improve the quality of the sub-image. For example, windowing level adjustment and gamma correction may be applied to improve the clarity or resolution of the sub-image. Other types of local enhancements, such as histogram equalization, noise suppression, sharpening, edge enhancement, frame averaging and motion artifact reduction, may also be automatically performed.

In addition, the sub-image may be further processed to improve the visibility of relevant information so as to provide enhanced diagnostic value. This can be done by visually suppressing the information that is not relevant to diagnosis. Alternatively, or in combination thereof, information relevant to diagnosis may be visually enhanced or highlighted. For example, the vascular structures in a breast image may be suppressed, while the lesion may be enhanced. Suppression of non-relevant information may be achieved by increasing the transparency, reducing the contrast and/or changing the color of corresponding pixels to make them less distinctive. Conversely, enhancement of relevant information may be achieved by increasing the opacity, increasing the contrast and/or changing the color of corresponding pixels to make them more distinctive. It should be noted these and other techniques of visual suppression and enhancement may be applied to both graphical and/or textual information.

Further, the corresponding CAD mark may be overlaid (or superimposed) on the sub-image. As discussed previously, CAD marks indicate the locations and/or shapes of ROIs. The CAD mark may be a pointer (e.g., cross-hair, arrow) or a shape (e.g., circle, square). The overlay of the CAD mark on the sub-image may be achieved by selective blending. For example, the image data representing the CAD mark can be selectively combined with the sub-image data such that the overlaid CAD mark is displayed with the desired color and opacity (or transparency). The opacity and color may be automatically chosen so that the enhanced annotations are visually distinguishable from the background image.

In addition, textual information derived may be overlaid on the sub-image or the enhanced annotation. The textual information may be derived from the image findings generated by the image processing unit 104. For example, such textual information may include CAD details such as the lesion type, the certainty of finding, the number of micro-calcifications, the size or density of the lesion, or the identification or location of the corresponding body part where the ROI is detected. Such information is particularly useful in facilitating the detection and diagnosis of a medical condition.

At 308, the viewing station 106 automatically generates a layout of the enhanced annotations. The relative locations, orientations and/or sizes of the enhanced annotations may be determined based on one or more spatial constraints. For example, the enhanced annotations may be re-located, re-shaped, re-sized (e.g., shrunk) or otherwise transformed (e.g., rotated or flipped) to satisfy various spatial constraints. The advantage of the automatic layout generation is that it enhances the efficiency of the inspection process by relieving the user of the manual task of adjusting and/or arranging the annotations to obtain a better read.

One exemplary spatial constraint is arranging the enhanced annotations such that they are located outside the subject area of the image. Another exemplary spatial constraint is to avoid overlap between enhanced annotations. Such spatial constraints are designed to avoid obstructing the view of information pertinent to diagnosis. Yet another exemplary spatial constraint is arranging the enhanced annotations such that they are as close as possible to the respective CAD marks that are overlaid in the subject area of the image. One advantage of this spatial constraint is that it draws the attention of the user to the information associated with the ROI indicated by the CAD mark, thereby making the inspection process more intuitive and efficient. Other types of constraints may also be imposed during the generation of the layout.

In one implementation, the vertical position of each enhanced annotation is determined such that it is as close to the vertical position of the image mark, without overlapping with other enhanced annotations. Further, the horizontal position of the enhanced annotations may be determined such that it is as close as possible to the contour or boundary of the subject area without overlapping with the imaged subject. Such procedure works well particularly when the subject area does not fill the entire image. Other methods of determining the layout may also be useful. For example, the layout may be determined such that the enhanced annotations do not overlap areas in the image that are of diagnostic interest to the user.

At 310, the enhanced annotations are overlaid on the image. The enhanced annotations may be arranged in accordance with the layout generated by step 308. The overlay of the enhanced annotations may be derived from, for example, selective blending methods. The image data of the enhanced annotations and the underlying image may be selectively combined to achieve the desired opacity (or transparency) and color. The opacity and color may be automatically chosen so that the enhanced annotations are visually distinguishable.

At 312, the viewing station 106 renders and displays the image with the overlaid enhanced annotations. The image may be displayed on a computer monitor or any other suitable display device. Alternatively, the image may be displayed on a hardcopy, such as a paper printout or a film-sheet viewable with a light box.

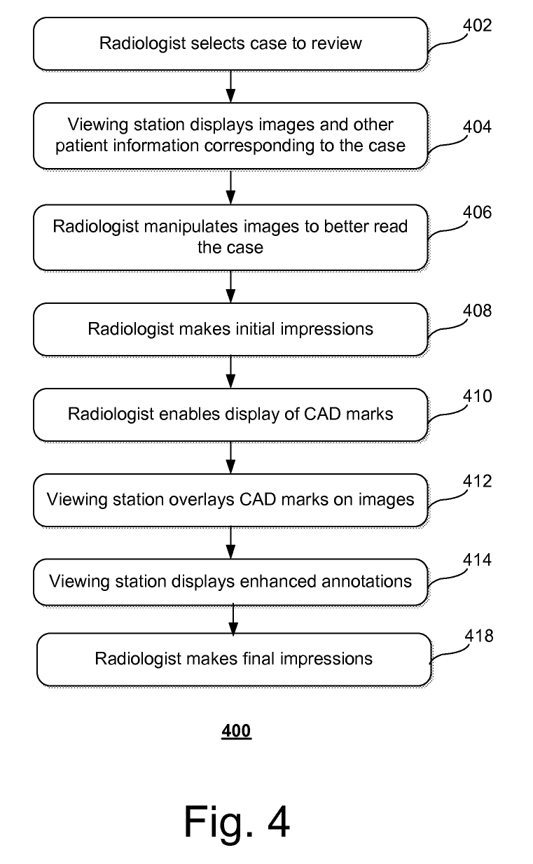

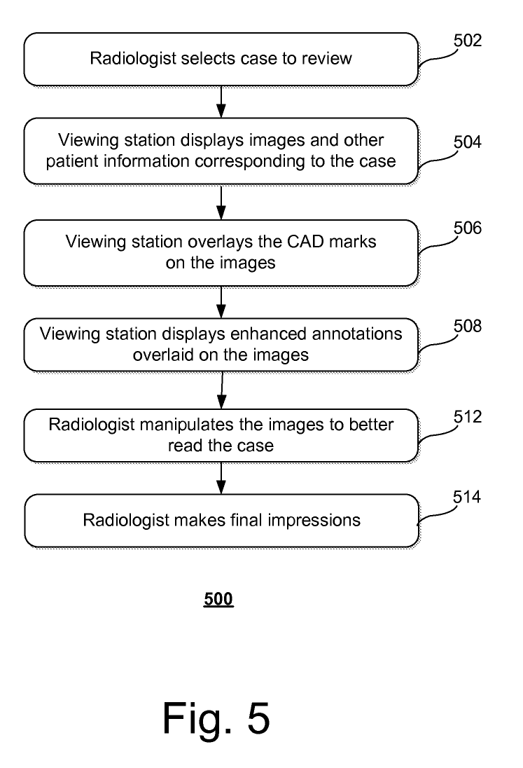

FIGS. 4-5 show exemplary workflows 400 and 500, which may be supported by the image processing system 100. It is to be understood that while a particular application directed to medical diagnosis using CAD technology is shown, the present invention is not limited to the specific embodiments illustrated. Other types of workflows may also be supported. The exemplary workflows 400 and 500 advantageously involve minimal manual adjustment. The radiologist or physician may focus on reviewing the images without having to spend much time in manipulating the images for a better read. Efficiency and accuracy in interpreting the images are thereby enhanced.

Referring to FIG. 4, an exemplary workflow 400 is shown where the image processing system 100 serves as a second reader in a CAD-assisted diagnostic process.

At 402, the radiologist selects the case to review. At 404, the viewing station 106 displays the images and other patient information to the radiologist. At 406, the radiologist manipulates the images to better read the case. At 408, the radiologist makes initial impressions from analyzing the displayed images. At 410, the radiologist enables the display of CAD marks. The CAD marks indicate the locations or shapes of ROIs in the images. At 412, the viewing station 106 overlays the CAD marks on the subject areas (e.g., breast or lung area) of the images.

At 414, the viewing station 106 renders and displays enhanced annotations overlaid on the images. The enhanced annotations may be generated by, for example, step 306 as previously discussed in relation to FIGS. 3a and 3b. Enhanced annotations may include magnified sub-images of ROIs and other CAD information, such as lesion type, certainty of finding, number of micro-calcifications, lesion size or density. Local image enhancements may also be automatically applied to the sub-images. In addition, the viewing station 106 may automatically position the enhanced annotations outside of the subject area and at locations as close as possible to the actual locations of the corresponding CAD marks. At 418, the radiologist makes final impressions based on the displayed information.

FIG. 5 illustrates an alternative exemplary workflow 500 that may be supported by the image processing system 100, where the image processing system 100 serves as a concurrent reader in the CAD-assisted diagnostic process.

At 502, the radiologist selects the case to review. At 504, the viewing station 106 displays images and other patient information corresponding to the case. At 506, the viewing station 106 overlays the CAD marks on the images to indicate the ROIs. At 508, the viewing station 106 displays enhanced annotations overlaid on the images. As discussed previously, such enhanced annotations may include, for example, magnified sub-images of ROIs indicated by CAD marks and other CAD information. Additionally, local image enhancements may be automatically applied to the sub-images. The viewing station 106 may automatically position the enhanced annotations outside the subject areas (e.g., breast area) in the images and as close as possible to the actual locations of the corresponding CAD marks. At 512, the radiologist manipulates the images to better read the case. At 514, the radiologist makes final impressions based on the displayed information.

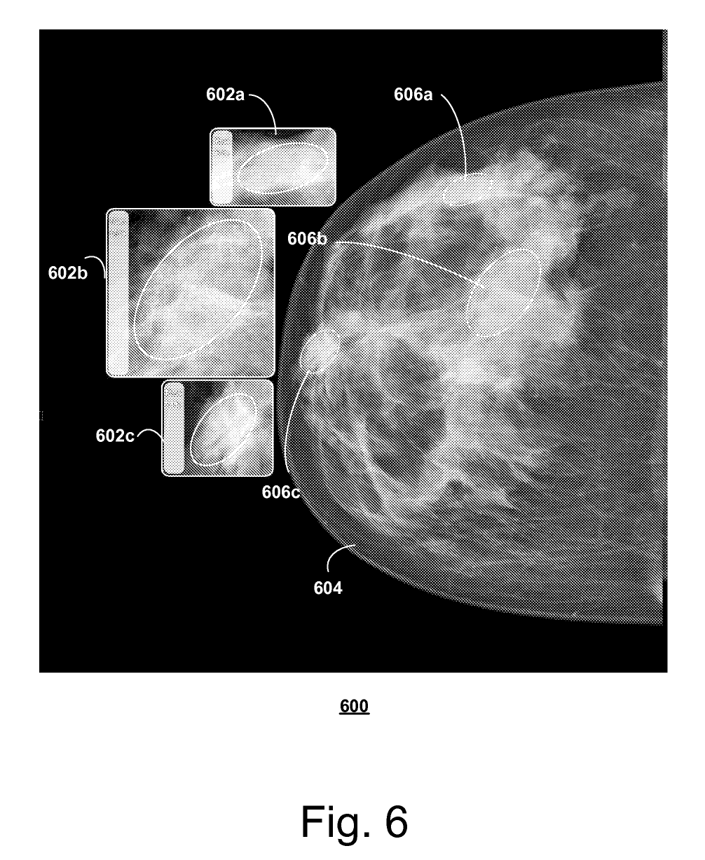

FIG. 6 shows an exemplary mammogram 600 with overlaid enhanced annotations 602a-c. Although only three enhanced annotations 602a-c are shown, it is to be understood than any other number of enhanced annotations (e.g., 1, 2, 4 or more) may also be displayed. The enhanced annotations 602a-c are displayed alongside the breast area 604 so that they do not obscure the imaged breast. In addition, the enhanced annotations 602a-c are aligned as close as possible to the corresponding CAD marks 606a-c respectively, without overlapping with each other. The sub-images of the ROIs indicated by the CAD marks 606a-c are magnified within the enhanced annotations 602a-c so as to provide a better view for inspection. Since all CAD information is presented at once in a layout that does not obscure pertinent portions of the image, the radiologist will easily be able to take into account all relevant information when making final impressions.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A method for supporting a workflow from a computer system, comprising:
(a) receiving, by the computer system, at least one image of a subject and at least one image finding identifying one or more regions-of-interest (ROIs) in a subject area of the image;
(b) generating, by the computer system, one or more enhanced annotations based on the image finding;
(c) overlaying the one or more enhanced annotations on the image; and
(d) displaying the image with the overlaid one or more enhanced annotations.

2. The method of claim 1 further comprises acquiring, by an imaging device, the image by at least one of a magnetic resonance (MR) imaging, computed tomographic (CT), helical CT, X-ray, positron emission tomographic, fluoroscopic, ultrasound, single photon emission computed tomographic (SPECT), or mammography technique.

3. The method of claim 1 further comprising processing, by the computer system using a CAD process, the image to generate the image finding.

4. The method of claim 1 further comprising defining, by a user via the computer system, the image finding.

5. The method of claim 1 wherein the image finding comprises at least a location and a shape of the one or more ROIs.

6. The method of claim 1 wherein the step (b) further comprises overlaying textual information derived from the image finding on the enhanced annotation.

7. The method of claim 6 wherein the textual information comprises at least one of a lesion type, certainty of finding, number of micro-calcifications, lesion size, lesion density, identification or location of a corresponding body part.

8. The method of claim 1 wherein the one or more enhanced annotations comprise at least one magnified sub-image of the ROI.

9. The method of claim 8 wherein the step (b) further comprises overlaying a CAD mark on the sub-image.

10. The method of claim 8 wherein the step (b) further comprises applying local image enhancement to the sub-image.

11. The method of claim 10 wherein said local image enhancement comprises at least one of gamma correction, windowing level adjustment, histogram equalization, noise suppression, sharpening, edge enhancement, frame averaging or motion artifact reduction.

12. The method of claim 1 further comprising:
(e) generating, by the computer system, a layout of the one or more enhanced annotations based on at least one spatial constraint; and
(f) overlaying the one or more enhanced annotations on the image arranged in accordance with the layout.

13. The method of claim 12 wherein the spatial constraint comprises avoiding overlap between the one or more enhanced annotations.

14. The method of claim 12 wherein the spatial constraint comprises positioning the one or more enhanced annotations outside the subject area.

15. The method of claim 12 wherein the spatial constraint comprises positioning the one or more enhanced annotations as close as possible to one or more corresponding CAD marks overlaid in the subject area of the image.

16. The method of claim 12 further comprises modifying the relative location, size or orientation of the one or more enhanced annotations to satisfy the spatial constraint.

17. The method of claim 1 further comprising improving visibility of relevant information in the image.

18. The method of claim 1 further comprising matching, by the computer system, the image finding to the corresponding image.

19. A computer-usable medium having a computer-readable program code tangibly embodied therein, said computer-readable program code adapted to be executed by a processor to implement a method for supporting a workflow from a computer system, comprising:
(a) receiving at least one image of a subject and at least one image finding identifying one or more regions-of-interest (ROIs) in a subject area of the image;
(b) generating one or more enhanced annotations based on the image finding;
(c) overlaying the one or more enhanced annotations on the image; and
(d) displaying the image with the overlaid one or more enhanced annotations.

20. A system for supporting a workflow, comprising:
an image processing unit operable to receive at least one image of a subject and generate at least one image finding identifying one or more regions-of-interest (ROIs) in a subject area of the image; and
a viewing station operable to generate one or more enhanced annotations based on the image finding, wherein the viewing station is further operable to overlay the one or more enhanced annotations on the image and display the image with the overlaid enhanced annotation.
